(19) United States
(12) Patent Application Publication
(10) Pub. No.: US 2021/0035182 A1
(43) Pub. Date: Feb. 4, 2021

(54) SYSTEM AND METHOD FOR GENERATING AUTOMATIC STYLING RECOMMENDATIONS

(71) Applicant: DANA TAMIR-TAVOR, HOD HASHARON (IL)

(72) Inventor: DANA TAMIR-TAVOR, HOD HASHARON (IL)

(21) Appl. No.: 16/074,089

(22) PCT Filed: Feb. 2, 2017
(86) PCT No.: PCT/IB2017/050572

§ 371 Date: Jul. 31, 2018

(51) Int. Cl. G06Q 30/06; A41H 1/02; A41H 3/00; G06N 20/00

(52) U.S. Cl. CPC G06Q 30/0631; G06Q 30/0621; G06N 20/00; A41H 1/02; A41H 3/007; G06Q 30/0643

(57) ABSTRACT

The disclosure herein relates to the fashion and styling industry. In particular, aspects of the disclosure relates to technologies and methods for generating automatic garment-based and outfit-based styling recommendations based upon selected physical body characteristics and garment characteristics that are most critical for good styling. The disclosure provides simplified rule-based styling logic. The rule based logic is using a small set of physical body characteristics referred to as styling anchors to be matched with a garment molds. The matching for a good styling is based upon applying a combination of associated rules of a garment mold specified as a major class definition of a garment type (skirts, pants, tops, jackets, dresses) with a sub-class definition (neckline shape, waistline position, sleeves, length) to provide a do-able and simplified process of personal styling recommendation.

### FIELD OF THE DISCLOSURE

The disclosure herein relates to fashion and styling. In particular, the disclosure relates to technologies and methods for the generation of automatic garment-based and outfit-based styling recommendations based upon selected physical body characteristics and garment characteristics that are most critical for good styling.

### BACKGROUND OF THE INVENTION

Fashion and styling is a multi-billion dollar industry with social and economic implications worldwide. The fashion industry has traditionally placed high value on design and creativity but has been slower to realize the potential of technology, particularly with respect to personal styling. In recent years fashion and technology seem to meet in an effort to produce algorithm-driven tools to make personal shopping a more efficient process. Mostly, the efforts have focused in the online shopping arena, on ways to overcome the problem of too many clothes returns that occur mainly because online fitting and online styling are almost impossible to achieve. At the same time, fashion e-commerce portals are using data not only to be branded as a fashion destination rather than only an online warehouse, but mainly to understand their clients' likes and needs in order to increase customer satisfaction resulting in the increase of sales. Most of the fashion houses are trying to recreate physical in-store and live experience for their virtual channels to dramatically increase their conversion rate and overcome the current problem where they are utilizing only about 30-35% of their online selling potential. Some of the technology startups are providing trending, forecasting fitting, measuring and other personalized services, all aiming to help the fashion industry to better exploit its business potential.

However, when attempting to provide Styling technologies the challenges to overcome are even bigger, as personal styling is based on complex relations between physical, cultural, socio-economical and mass-psycology parameters as well as personal likes and needs, that when being merged, reside in the fuzzy-logic arena. The online styling services offered today are based mainly on human stylists “behind the scene” providing personal styling recommendations based on first-time shoppers providing many physical measurements and filling up quizzes and questionnaires Additionally, many people are not aware of what it takes to dress properly so that what they wear not only fits them but also suits their body characteristics, their age, habits and way of life. However, when attempting to provide an automated styling solution, it is particularly noted that the endless possible garments and garment combinations are turning in many cases, the styling process into almost an impossible task. It is particularly noted that in the Fashion and Styling industries there is no reference to the concept of combining a limited number of physical body characteristics with a reduced and manageable amount of garment shapes to allow a do-able automated styling process that provides good styling.

The need remains therefore for an automated styling process using a reduced and manageable garment shapes.

The invention described herein addresses the above-described needs.

### SUMMARY OF THE INVENTION

According to a one aspect of the disclosure, a method is taught for generating automatic styling recommendations, the method comprising: categorizing body shapes into a finite number of body groups; classifying garments into a finite number of garment molds; generating a recommendation function operable to receive at least one request parameter and to return at least one garment recommendation according to styling rules; receiving a recommendation request for a particular body group, said recommendation request characterized by at least one request parameter; applying the recommendation function to the received request parameters; and reporting a styling recommendation based upon the at least one garment recommendation returned by the recommendation function.

As appropriate, the step of categorizing the body shapes into a finite number of body groups comprises: defining a set of body anchors each of the body anchor representing a lifestyle-independent body characteristic; and assigning each body group a value for each body anchor.

Variously, the set of body anchors comprises: horizontal body type; vertical body type; and height.

As appropriate, each of the body group is assigned a horizontal body type value selected from: A(“Pear); X(“Cherry”); H(“Banana”); V(“Strawberry”); O(“apple”).

Variously, each of the body group is assigned a vertical body type value selected from a group consisting of: high waistline, low waistline and mid waistline.

Variously, each of the body group is assigned a height value selected from a group consisting of: below average, average and above average.

Variously, the step of categorizing the body shapes into a finite number of body groups comprises categorizing body shapes into 45 styling entities.

Additionally, the method may include assigning each body shape to one of N_st styling entities, each styling entity comprising a unique combination of the body anchors, the method comprising: assigning the body group one value selected from N_horiz horizontal body type values; assigning the body group one value selected from N_vert vertical body type values; and assigning the body group one value selected from N_height height values; such that there are a total of N_st styling entities, where N_st is equal to the number of combination of N_horiz, N_vert and N_height.

As appropriate, the method further includes assigning each body shape to one of N_st styling entities, each styling entity comprising a unique combination of n body anchors, such that

$$N\_st = {\prod }_{1}^{n} N\_i$$

where N_i is the number of values of the ith body anchor.

Additionally, the step of classifying garments into a finite number of garment molds comprises: defining a set of garment types; and for each of the garment type, defining a set of garment major classes corresponding to the garment molds.

Variously, the set of garment types are selected from a group consisting of skirts, dresses, pants, jackets and tops.

Accordingly, the step of categorizing garments into a finite number of garment molds further comprises, defining a set of garment sub-classes corresponding to garment parts associated with the garment types.

Variously, the selected garment parts associated with tops are selected from a group consisting of garment length, sleeves, and neckline shapes.

Variously, the selected garment parts associated with skirts are selected from a group consisting of garment length and garment waistline position.

Variously, the selected garment parts associated with pants are selected from a group consisting of garment length and garment waistline position.

Variously, the selected garment parts associated with dresses are selected from a group consisting of garment length, sleeves, neckline shapes and waistline position.

Variously, the selected garment parts associated with jackets are selected from a group consisting garment length, sleeves, and neckline shapes.

As appropriate, the step of generating a recommendation function comprises constructing a multi-dimension recommendation matrix.

Where appropriate, the multi-dimension recommendation matrix comprises an array of cells each of the cells corresponding to a particular body group and a particular garment major class, wherein each of the cells is assigned a styling-score according to the styling rules.

Variously, each of the cells is assigned a styling-score selected from a group consisting of very good, good, ok and avoid.

As appropriate, the multi-dimension recommendation matrix comprises an array of cells each corresponding to a particular body group and a particular garment sub-class, wherein each of the cell is assigned a styling-score according to the styling rules.

Variously, each of the cells is assigned a styling-score selected from a group consisting of very good, good, ok and avoid.

As appropriate, the step of applying said recommendation function comprises: obtaining a first styling-score pertaining to a particular garment major class for the particular body group; obtaining a second styling-score pertaining to a particular garment sub-class for the particular body group; and merging the first styling-score and the second styling-score according to styling rules for the particular body group to obtain a first-level combined styling-score.

As appropriate, the step of applying said recommendation function further comprises: obtaining a third styling-score pertaining to garment length for the particular garment major class, and for the particular body group; and merging the third styling-score and the first-level combined styling-score according to styling rules for the particular body group to obtain a second-level combined styling-score.

As appropriate, the step of applying the recommendation function further comprises: obtaining a further styling-score pertaining to other garment-features; and merging the further styling-score and a previous-level combined styling-score according to styling rules for the particular body group to obtain a next-level combined styling-score.

As appropriate, the step of generating a recommendation function comprises: accessing a database populated with styling data harvested from a distributed computing network; and applying machine learning algorithms to generate styling rules for all body shapes.

As appropriate, the step of reporting a styling recommendation further comprises: generating a set of outfit styling-rules; and applying the outfit styling rules to produce at least one outfit based recommendation comprising a combination of compatible said garments recommendations.

As appropriate, the step of generating the set of outfit styling-rules comprises: accessing a database populated with styling data harvested from a distributed computing network; and applying machine learning algorithms to generate outfit styling rules for all body shapes.

It is according to another aspect of the disclosure, an automatic styling recommendation system is disclosed, operable to provide personal styling recommendations, the styling recommendation system comprising: a processing unit operable to manage and control algorithmic outfit-styling analysis; a garment-based styling component operable to provide rule-based logic for said styling recommendation system; a styling logic interface configured to provide a third party software module an interfacing layer with the styling logic component via the processing unit; and a knowledge data repository unit operable to store system related elements; wherein the styling recommendation system is operable to: receive at least one request parameter; produce at least one analysis result: and report at least one outfit-based and or garment-based recommendation comprising the at least one analysis result, according to a set of outfit-styling rules.

As appropriate, the at least one analysis result of the automatic styling recommendation system comprises a combination of compatible garments.

Additionally, the automatic styling recommendation system may further include an outfit-based styling engine operable to update the knowledge data repository with data pertaining to said set of outfit-styling rules.

Moreover, the automatic styling recommendation system may further include a display module operable to provide system visualization for the styling recommendations.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1A is a diagram schematically representing possible styling anchors for categorizing body groups (styling entities) characterized by a selected combination of physical body characteristics;

FIG. 1B is a diagram schematically representing possible garment categories for classifying garments;

FIG. 2 is a block diagram of a possible Automated Styling Recommendation System (ASRS) architecture schematically representing one possible architecture layout;

FIG. 3 is schematic configuration diagram of a possible system distribution of an Automated Styling Recommendation System (ASRS), for providing styling recommendation for a user in various operational modes;

FIG. 4A is a flowchart representing selected actions illustrating a possible method for providing automatic personal styling recommendations of outfits or clothes to be worn or purchased;

FIG. 4B is a flowchart representing selected actions illustrating a possible classification method for categorizing of body shapes into a finite number of body groups;

FIG. 4C is a flowchart representing selected actions illustrating a possible categorization method for classifying garments into a finite number of garment molds and garment parts;

FIG. 4D is a flowchart representing selected actions illustrating a possible assignment method for assigning values to each body anchor of a body group;

FIG. 5 is a flowchart representing selected actions illustrating a possible logic flow of a garment-based styling recommendation software application using a recommendation matrix;

FIG. 6 is a flowchart representing selected actions illustrating another possible logic flow of an outfit-based styling recommendation software application using machine learning and big data techniques;

FIG. 7 represents an example of a styling recommendation matrix for use with the current disclosure.

FIGS. 8A, 8B, 8C represent possible process descriptions of an outfit-based styling recommendation application in various use cases where the user is selecting clothes to wear from his closet, or clothes to purchase from fashion stores for various occasions.

### DESCRIPTION OF EMBODIMENTS

Aspects of the present disclosure relate to systems and methods for the generation of garment-based and outfit-based styling recommendations based upon body physical characteristics of a subject and any possible garments.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

As used herein the terms “Body Groups” or “Styling Entities” refer to particular combinations of physical body characteristics such as horizontal body type or shape, vertical body type or shape, height, skin complexion, skeletal structure, and the like.

As used herein, the terms “Styling Anchors” or “Body Anchors” refer to lifestyle-independent physical body characteristics.

As used herein, the term “Lifestyle-independent” describes any factor which is not influenced by the way of life or the physical habits (“living habits”) of a subject, such as the environment humans grow in, eating habits, sleeping habits, physical training habits, personal habits, and the like.

As used herein, the term “Garment types” refers to garment groupings or classification such as dresses, skirts, pants, tops, jackets and the like.

As used herein, the term “Garment Parts” refers to the components of the garment such as sleeve, waistline, neckline, length and the like.

As used herein, the term “Garment Features” refers to other characteristics of the garment such as color, fabric, texture and the like.

As used herein, the term “Garment Molds” refers to garment major classes which may be used as the core essentials to determining the garments contours that most represent existing or future garment shapes. Garment Molds may be characterized by basic garment silhouettes such as used in pattern making providing a particular garment shape.

Systems and methods of the current disclosure are described for generating automatic styling recommendations of outfits or clothes to be worn or to be purchased. The recommendations are generated according to a plurality of parameters such as: body physical characteristics, personal attributes and habits, events to be attended, available clothes, garment classification, outfit usage history, styling rules, fashion guidelines, user feedback, feedback from social networks and the like.

### Physical Body Characteristics:

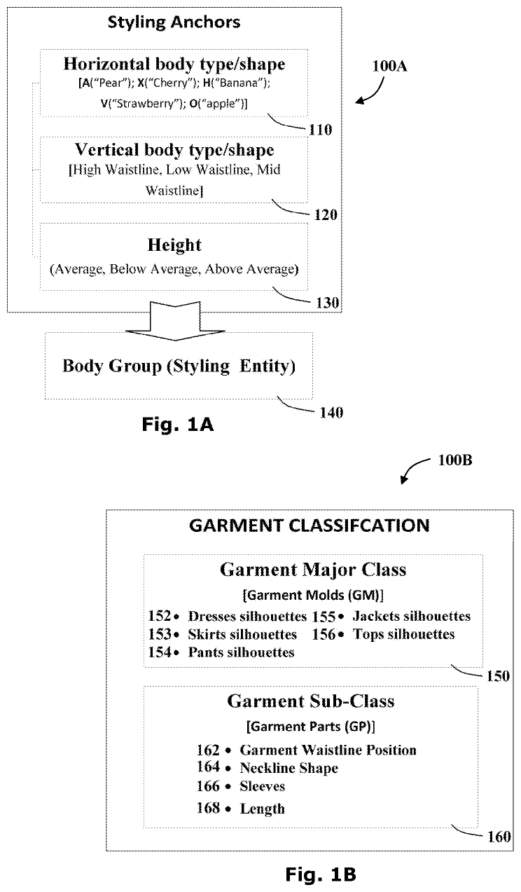

Reference is now made to FIG. 1A, there is provided a diagram schematically representing a possible set of selected styling anchors, which is generally indicated at 100A, for categorizing body groups (styling entities). Each body group is characterized by a selected combination of physical body characteristics.

Physical body characteristics can include a variety of things and may encompass anything one can describe about a person, just on sight. Physical body characteristics may include lifestyle-independent characteristics such as skeletal structure characteristics, height characteristics (short tall, petite and the like), skin complexion characteristics (dark, light, pale, tan and the like), and lifestyle-dependent characteristics such as body weight or distribution of muscle and fat and the like, breasts, hair color characteristics, (blond, red, brown, grey, white, black and the like), hair style characteristics (curly, straight, short, long, receding and the like) and more.

The physical body characteristics, known as styling anchors or body groups, within the scope of the current disclosure refer to a combination of a set of selected lifestyle-independent characteristics which do not vary over the adult life of a subject. By way of example only, three such parameters within the scope of the current invention include: horizontal body type 110, vertical body type 120 and height 130. As stated hereinabove, the set of physical body characteristics may include various additional characteristics, yet, it is particularly noted that the current disclosure introduces the selected set of physical body characteristics representing a novel set of body categories forming a styling entity 140. It has surprisingly been found that the combination of these three selected styling anchors generates an entity greater than the sum of its parts, therefore referred to as a body group or a new styling entity 140.

The horizontal body type or shape 110 styling anchor may include a body shape ‘A’ (“Pear”) parameter, a body shape ‘X’ (“Cherry”) parameter, a body shape ‘H’ (“Banana”) parameter, a body shape ‘V’ (“Strawberry”) parameter and a body shape ‘O’ (“Apple”) parameter.

For example, as known in the fashion industry, the characteristics associated with body shape ‘A’ (“Pear”) are defined such that the hips are broader than the shoulders and the waist gradually slopes out to the hips; similarly, the characteristics associated with body shape ‘O’ (“Apple”) are defined such that there is a little or no definition of waist and with full chest and upper back.

The vertical body type or shape 120 may be used as a styling anchor to define vertical body proportions and may include a ‘High Waistline’ parameter (Longer legs than torso), a ‘Low Waistline’ parameter (Longer torso than legs) and a ‘Mid Waistline’ parameter (Even body proportions bellow and above waistline).

The height 130 styling anchor may be simplified to include one of the three parameters, an ‘Average’ parameter, a ‘Below Average’ parameter and an ‘Above Average’ parameter.

Accordingly, as described hereinabove, it is particularly noted that using the novel combination of the three characteristics of the “Styling Anchors” are selected_from among other physical characteristics being used in the field of styling. Thus, the selected physical characteristics may determine that human beings are classified into 45 body groups or styling entities, comprised of the possible combinations of five horizontal body type (or shape) characteristics, three vertical body type (or shape) characteristics and three height characteristics.

These three characteristics are referred to as “Styling Anchors”. It has surprisingly been found that these anchors do not change due to personal habits and behavior, way of life or environmental influences.

For those skilled in the art to which this invention pertains will readily appreciate that numerous changes, variations and modifications can be made to the styling entities, various other physical characteristics, styling anchors and the like, without departing from the scope of the invention mutatis mutandis. Thus, it is particularly noted that the presented set is not intended to be limiting and is being used to allow simplification. Other styling parameters may be added based upon continual analysis and extent of machine learning technology incorporated.

It has surprisingly been found that the combination of these three particular styling anchors provides a single new entity that when creating styling rules for, it provides better styling results than the aggregation of styling rules for each of its parts separately. Nevertheless, it is noted that, where appropriate, classification of body shapes into body groups may use other body characteristics or body anchors, as required.

It is particularly noted that in the Fashion and Styling industries there is no reference to the concept of the combination of parameters defined above, not by the name ‘Body Group’ nor by any other name. Although the term ‘Body Group’ has been used to relate to entities dealing with body health, body building or Physiotherapy, these are unrelated and bear only nominal similarity with the term used here. In the Fashion and Styling arena, one may find references to “body type/s” or “body shape/s”, however these related specifically to a single body characteristic. There has been no previous effort to combining selected styling anchors into a more useful single new integrated Styling entity and thereby categorizing the human beings into a small number of styling entities, such as the above described Body Group concept.

It is further noted that the nature and number of the particular Styling Anchors used in the combination may change, which may change the number of Body Groups.

Various embodiments of the invention relate to Garment Classification. It is particularly noted that the endless possible garments shapes are herein significantly reduced to a finite and manageable number.

This reduction has been enabled by the unique characterization of the garment (any garment) into one major class and many sub classes as outlined below.

### Garment Categories:

Reference is now made to FIG. 1B, there is provided a diagram schematically representing selected garment categories, which is generally indicated at 100B, for classifying garments. Regarding the parameter of garment classification, the current disclosure introduces a new set of garment categories 100B. Garments may be categorized into major classes 150 and sub-classes 160. The Major classes 150, also referred to as Garment Molds (GMs) or Crucial Garment Silhouettes (CGS) are characterized by basic garment silhouettes such as used in pattern making.

Major classes may be associated with various garment types such as dresses silhouettes 152, skirts silhouettes 153, pants silhouettes 154, jackets silhouettes 155 and tops silhouettes 156. Examples of major classes for each of these garment types are given below.

The sub-classes 160 refer to aspects or parts of the garments such as garment waistline position 162, neckline shape 164, sleeves 166, and length 168 and combinations thereof. Accordingly, the combination of the sub-classes into the garment molds may define a unique garment shape.

It is noted that the garment molds are used as the core essentials to determining the garments contours that most represent existing or future garment shapes. This is done by minimizing the numerous possible garment silhouettes into a very small number of garment molds that are the core essentials for good styling. Accordingly, for each type of garment a number of garment molds are created and any particular garment can be assigned into one such garment mold. It is noted that the garment molds are not necessarily the same basic garment silhouettes that are used in pattern making. Furthermore, any particular garment is meant to fit into one mold only to provide appropriate styling recommendations

Sub classes refer to parts of any garment, that when some or all of the parts are integrated into a garment mold, we get a unique garment shape. The Sub classes are construed of the parts of a garment that are defined as having the most significant influence on good styling. Thus, as specified in this example, one particular selection of Sub classes includes:

Garment waistline position on the body (for skirts, dresses & pants)

Neckline shape (for dresses and tops)

Sleeves (for dresses & tops)

Length (for all garment types)

It is noted that the current list of Major classes and associated sub-classes are presented by way of example in a non-limiting manner. Thus, as appropriate, other Major classes may be introduced and other Sub-classes may be added, accordingly.

It is further noted that with regard to the Major classes 150, the following may be applicable:

Optionally, the set of garment molds associated with dresses silhouettes 152 may be selected from a group consisting of: Straight, A-line, and others.

Optionally, the set of garment molds associated with skirts silhouettes 153 may be selected from a group consisting of: Pencil, A-line, and others.

Optionally, the set of garment molds associated with pants silhouettes 154 may be selected from a group consisting of: Skinny, Straight, and others.

Optionally, the set of garment molds associated with jackets silhouettes 155 may be selected from a group consisting of: Straight, A-line, and others. Optionally, the set of garment molds associated with tops silhouettes 156 may be selected from a group consisting of: Straight, A-line, and others

It is noted that although the above examples are provided for illustrative purposes, other major classes may be applicable.

It is noted that with regard to the Sub-classes 160, the following may be applicable:

Optionally, the garment parts associated with dresses silhouettes 152 may be selected from a group consisting of: length, sleeves, neckline shape and garment waistline position.

Optionally, the garment parts associated with skirts silhouettes 153 may be selected from a group consisting of: length and garment waistline position.

Optionally, the garment parts associated with pants silhouettes 154 may be selected from a group consisting of: length and garment waistline position.

Optionally, the garment parts associated with jackets silhouettes 155 may be selected from a group consisting of: length, sleeves, and neckline shape.

Optionally, the garment parts associated with tops silhouettes 156 may be selected from a group consisting of: length, sleeves, and neckline shape.

Optionally, Length value of a garment part associated with dresses silhouettes 152 and skirts silhouette 153 may be selected from a group consisting of: Mini, Midi/Knee/Bermuda, 7/8 and Maxi.

Similarly, associated values other may be combined with other garment-types.

Optionally, Sleeves value of a garment part associated may be selected from a group consisting of: Sleeveless, Short, and others.

Optionally, Garment Waistline Position value of a garment part associated may be selected from a group consisting of: High, Middle , Low.

Optionally, Necklines value of a garment part associated may be selected from a group consisting of: Round, V/U neck, and others.

It is also noted that, although the above examples are provided for illustrative purposes, other sub-classes may be applicable.

Optionally, additional or alternative sub-classes 160 may be used.

It is particularly noted that parameters such as the body groups, body anchors and garment classifications, garment classes, garment categories, garment parts or the like, as described hereinabove in FIGS. 1A-B, may be used by the Automatic Styling Recommendation System (ASRS). The values of these parameters may serve as inputs into a styling recommendation function or into a styling recommendation matrix, operable to generate outfit and garment styling recommendations. The styling recommendation matrix itself may be generated according to a subject's body group, garment classes and relevant styling rules. It is particularly noted that styling rules may be pre-configured. Additionally or alternatively, as more data is gathered, styling algorithms and methods may be used, relying on gathered data, to generate the styling rules. Combining the styling algorithms with machine learning methods, may improve the generating of styling recommendations.

### Automatic Styling Recommendation System (“ASRS”)

It is noted that the software module architecture of the Automatic Styling Recommendation System (ASRS), as described hereinafter, may provide various technological implementations configured to serve different needs. The applications of the ASRS system may include a software application for an outfit calendar, automatic styling, outfit and garment recommendations, online and outdoor shopping recommendations also taking into consideration existing garments in personal closet, location based recommendations, possibly on a mobile communication device such as a smart phone or the like. Additionally or alternatively, a standalone feature to be incorporated into or interfaced with third party fashion technology products as appropriate, or Plug-ins in e-commerce stores.

### System Architecture and Layout

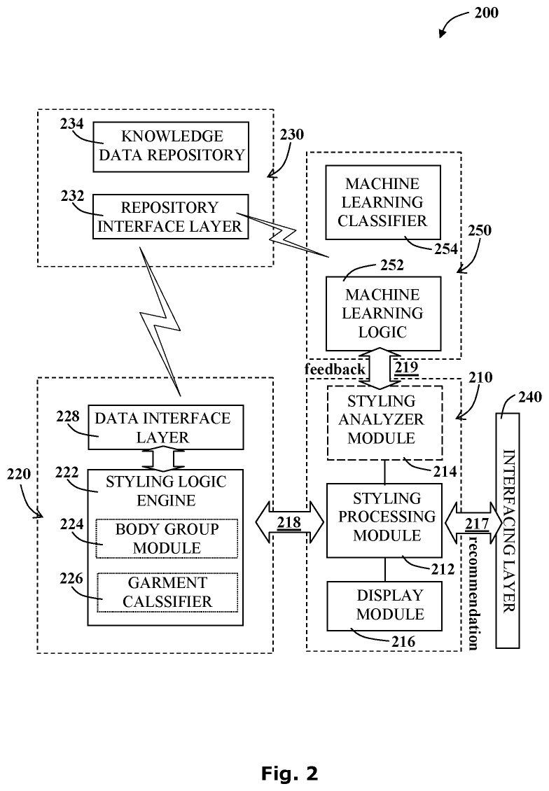

Reference is now made to FIG. 2, there is provided a block diagram of a possible Automated Styling Recommendation System (ASRS) architecture, which is generally indicated at 200, representing one possible module architecture layout.

It is stressed that the particulars of the presented architecture is shown by way of example and for purposes of illustrative discussion only. It is noted that other alternatives may be applicable to serve the needs of the current disclosure.

The system architecture 200 may include a processing unit 210 configured to interface using a styling channel 217 and further via an interfacing layer 240 with external software modules such as users' devices, e-commerce stores and OEM technologies, a garment-based styling component 220 operable to provide rule-based logic for a styling system, a knowledge data repository 230 and an outfit-based styling engine 250 operable to utilize proprietary machine learning algorithms to provide improved garment-based recommendations and outfit-based styling recommendations.

The processing unit 210 may further include a styling processing module 212 configured to manage and control the algorithmic analysis executed to provide styling recommendations. Optionally, the processing unit 210 includes a styling analyzer module 214 operable to control gathering of styling information and a display module 216 configured to provide system visualization for the styling recommendations. Optionally, the system visualization may provide display according to a desired computing device. The processing unit may be operable to receive at least one request parameter and produce one or more analysis results and further report at least one styling recommendation comprising at least one of the analysis results comprising a combination of compatible garments, according to a set of outfit-styling rules.

Additionally, it should be appreciated that the styling processing module 212 may be configured to communicate with the garment-based styling component 220 via an interfacing channel 218. The interfacing channel 218 may be operable to allow also remote communication in the case that the garment-based styling component 220 is installed on a separate machine.

The garment-based styling component 220 may further include a styling logic engine 222 comprising a Body Group module 224 and a garment classifier module 226. The styling logic engine 222 may further interact with the data repository unit 230 via the data interface layer 228.

The knowledge data repository 230 may store data associated with the styling logic uploaded at initial setup or updated/accumulated at run time, users' associated information, social networks information, matrix recommendations, history (events, styling recommendations and the like), calendar associated data, garment images and more.

The garment-based styling engine 220 may be operable to continuously being updated by the knowledge data repository 230 with data pertaining to a set of garment -styling rules, analyzed by the machine learning logic module 252.

The outfit-based styling engine 250 may include a machine learning logic 252 and a machine learning classifier 254 based on accumulated Big Data associated with classifications of garments, outfits, user behavior and user personal attributes analysis and more. The outfit-based styling engine 250 may be operable to continuously update the knowledge data repository 230 with data pertaining to a set of outfit-styling rules.

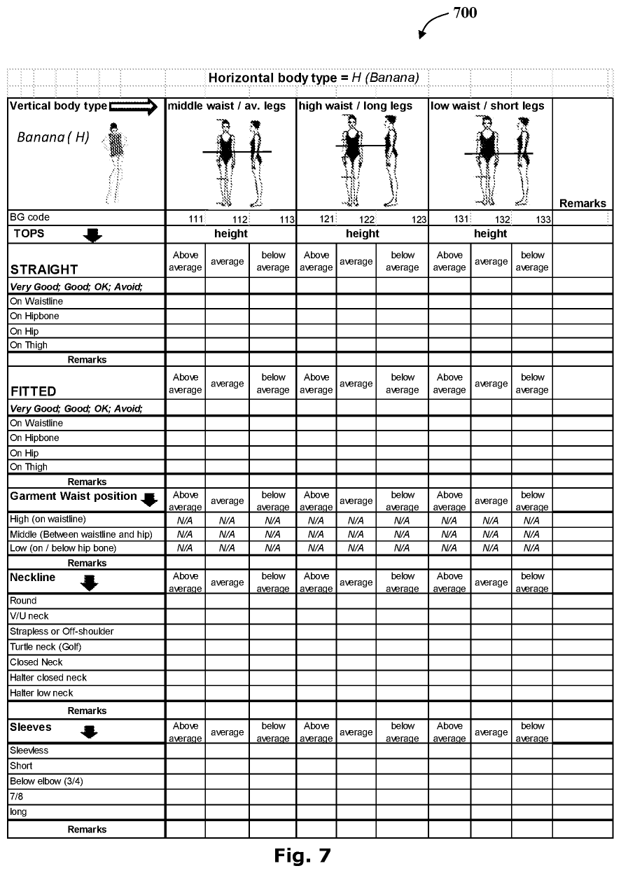

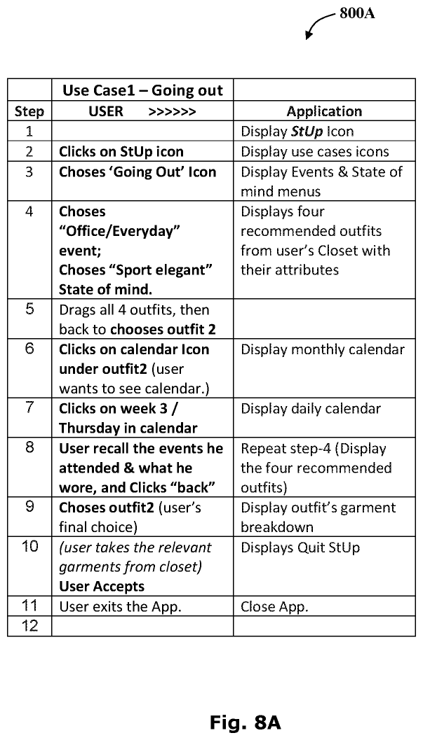

It is noted that the “Body Groups” and “Garment Classification” mechanisms together for the garment-based styling recommendation process, may enable the overcoming of the ‘Fuzzy logic’ that features the Styling arena, by creating coherent and crucial Styling Rules that may be reflected in a multi-dimension recommendation matrix. (“BG-recommendation-matrix”), as illustrated in FIG. 7.

It is noted that although this may use only a small proportion of styling parameters, it is a surprising result of the analysis that very high quality good-styling results may be achieved thereby.

It is also noted that the machine learning mechanisms are utilized to operate in the “Fuzzy logic” arena by combining non-measurable “soft data” (like crowd wisdom), with measurable information (like the styling recommendation matrix rules), to provide the ultimate Automatic Styler.

The ASRS styling recommendation logic may be derived from the structure of the matrix: based on the user's Body Group, the ASRS system is configured to collect the relevant styling rules that are related to the Garments' Major and Sub classes, and by merging the Major class and sub-classes rules, it creates the most suitable garments to a specific Body Group, for a specific user.

The rules embedded in the BG-recommendation-matrix are changeable.

Where required, the ASRS system may include not only the “BG-recommendation matrix” but also other styling algorithms and methods. These may also utilize Big Data and Machine Learning, as described hereinabove, where styling rules may be automatically generated based upon gathered data.

Those skilled in the art to which this invention pertains will readily appreciate that numerous changes, variations and modifications can be made without departing from the scope of the invention mutatis mutandis.

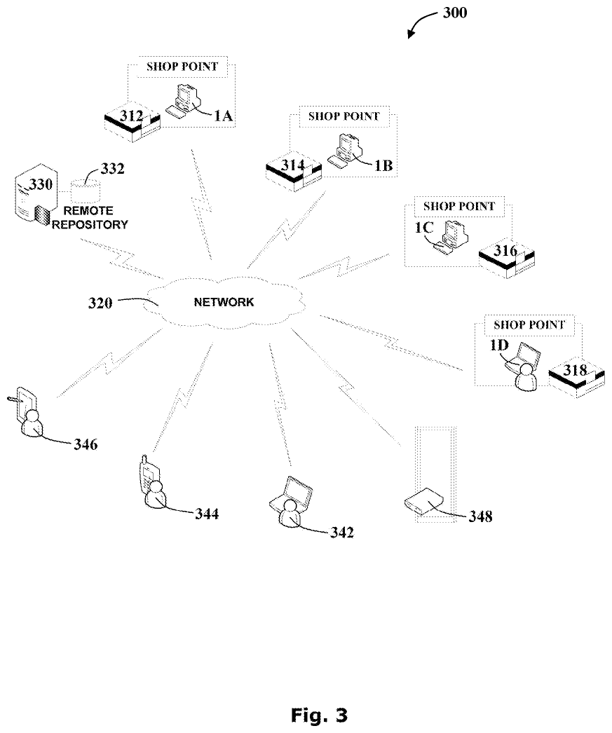

Reference is now made to FIG. 3, there is provided a configuration diagram of a possible system distribution representing an Automatic Styling Recommendation System, which is generally indicated at 300, the styling recommendation system is used for providing styling recommendation for a user in various operational modes.

The styling recommendation system distribution may include a client side and a server side. The client side may be used within a shop point, for example, such as shop points 312, 314 and 316 each having its own firm computing system (1A, 1B and 1C respectively) and a standalone styling feature may be incorporated into or interfaced with third party fashion technology products and/or e-commerce stores such as shop pints 312, 314, and 316, as appropriate, within those computing systems (1A, 1B and 1C).

The client side may further include another shop point 318 with a standalone dedicated styling recommendation system 1D, providing full scope styling functionality of the ASRS system.

Yet, additional forms of client applications, as a standalone system, for personal styling usage may exist such as on a laptop 342 operable to execute a standalone APP, similar to the standalone application 1D associated with the point shop 318; a mobile communication device (smartphone) 344 and a mobile communication device (tablet) 346, both operable to execute a standalone software App installable from Apple ‘App Store’ for iOS devices and ‘Google Play’ for Android devices and a computerized wardrobe unit 348.

The Server side may include a remote server 330 in communication via a network 320, via an interfacing layer as described in FIG. 2, hereinabove. The data repository 332 may be included as a separate unit on the remote server 330 or installed on a separate server machine.

It is noted that the garment-based styling component 220 (FIG. 2) may be installed on the remote server 330, including related processing components of the system, namely, the processing unit 210 (FIG. 2) and the outfit-based styling engine 250 (FIG. 2).

Furthermore, as the system may be implemented using a set of software modules operable to communicate via appropriate software interfaces, as described hereinabove in FIG. 2. Various components may be hosted on a single machine or distributed according to needs of the product implementation (standalone, interfaced and the like).

### Rule-Based Logic:

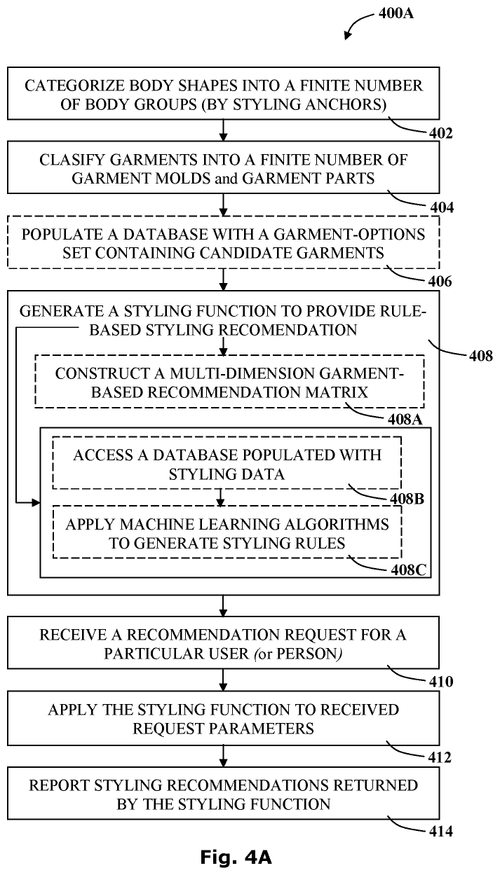

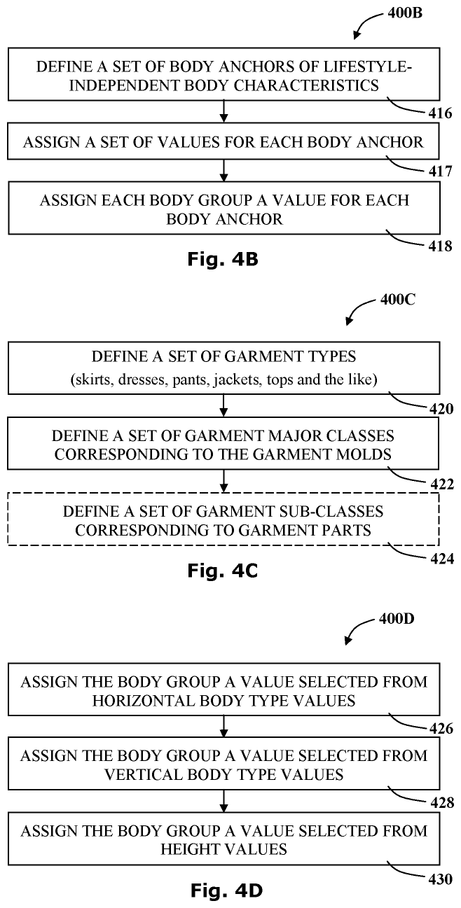

Reference is now made to FIG. 4A, there is provided a flowchart representing selected actions illustrating a possible method configured for fashion purposes, which is generally indicated at 400A, for providing automatic personal styling recommendations of outfits to be worn or clothes to be purchased. The outfit styling recommendations may be generated according to a plurality of parameters such as: body physical characteristics, personal characteristics and habits, available clothes, garment classification, outfit usage history, styling rules, fashion guidelines, user feedback, feedback from social networks and the like.

It is particularly noted that the method 400A may be activated by a user of a styling software application, possibly executed on a mobile communication device such as a smart phone, tablet or the like, as described hereinabove. Additionally or alternatively, the method 400A may present a standalone feature to be incorporated into or interfaced with third party fashion technology products as appropriate or Plug-ins in e-commerce shops.

The method 400A includes the following steps:

In step 402—the system is categorizing body shapes into a finite number of body groups determined by a set of styling anchors, as described hereinafter, in FIG. 4B.

In step 404—the system classifies garments into a finite number of garment molds and garments parts determined by a set of styling anchors, as described hereinafter in FIG. 4C.

In step 408—the system generates a styling function operable to provide rule-based styling recommendations. It is noted that the styling system is operable to receive at least one request parameter and to return at least one garment styling recommendation according to the styling rules. The step of generating the styling recommendation function may include constructing a multi-dimension garment-based recommendation matrix (step 408A), as described hereinafter in FIG. 7. Additionally or alternatively, the step of generating the styling recommendation function may include accessing a database populated with styling data harvested from a distributed computing network (step 408B); and applying machine learning algorithms to generate styling rules for all body shapes (step 408C).

In step 410—the system receives a recommendation request for a particular user or person, whereas the recommendation request is characterized by at least one request parameter;

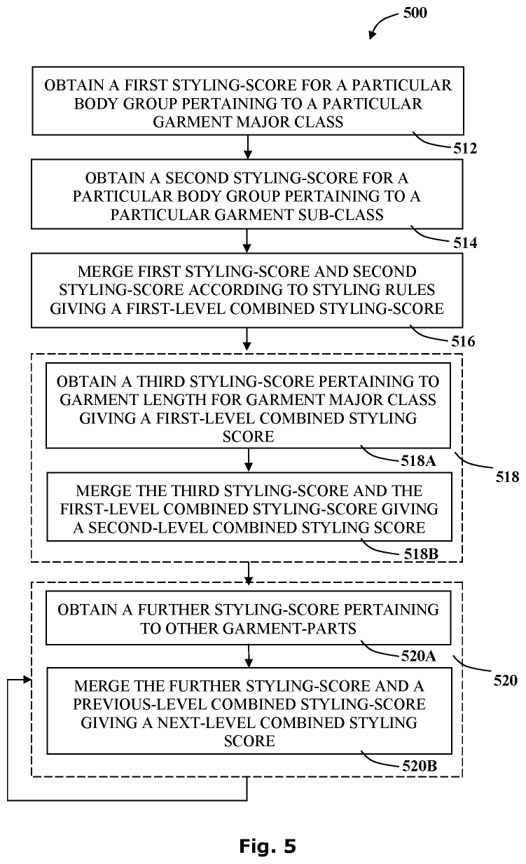

In step 412—the system applies the styling function to the received request parameters, to generate at least one styling recommendation (as presented in FIG. 5, hereinafter); and

In step 414—the system reports the styling recommendation based upon at least one garment styling recommendation returned by the styling recommendation function. Additionally or alternatively, the step of reporting may include generating at least one outfit-based recommendation comprising a combination of recommended garments and styling rules generated by the machine learning mechanism.

Where appropriate, in step 406—the system populates a database with a garment-options set containing candidate garments. The garment options set may, for example all the garment items known to be available to a subject, perhaps the contents of the subject's personal wardrobe or the garments available for the subject at a given budget, from a given store, from a given mall, from a given clothes library or the like. Additionally, other associated data needed to generate the styling recommendations may be stored in the data repository, such as garment molds and parts, body groups, styling rules and the like. Accordingly, the styling recommendation may be limited to outfits combining garments selected from the garment options set.

Furthermore, reporting may be presented textually, in a matrix format, in a table or provide a suitable graphical display.

Reference is now made to FIG. 4B, there is provided a flowchart representing selected actions illustrating a possible categorization method, which is generally indicated at 400B, for categorizing body shapes into a finite number of body groups as presented in FIG. 4A, step 402.

The method 400B includes the following steps:

In step 416—the system defines a set of body anchors each body anchor representing lifestyle-independent body characteristics. The selected body anchors, as noted in previous sections, consist of characteristics which do not change over the adult life of the subject. As appropriate, the term ‘lifestyle’ is referred to human physical habits (“living habits”), like the environment humans grow in, eating habits, sleeping habits, physical training habits and the like. For example, skeletal properties of the body such as a horizontal body type, a vertical body type and a height type may provide lifestyle independent anchors which, in combination, may define a styling entity to form the basis for an efficient styling recommendation.

In step 417—the system assigns a set of values for each body anchor, and

In step 418—the system assigns each body group a value for each body anchor that together construe the body group code.

It is noted that the method 400B may include assigning each body shape to one of N_st styling entities, each styling entity comprising a unique combination of n body anchors, such that the number of styling entities N_st equals the arithmetic product of the numbers of each body anchor, as given by:

$$N\_st = {\prod }_{1}^{n} N\_i$$

where N_i is the number of values of the i^{th} body anchor.

It is further noted that the step of categorizing the body shapes into a finite number of body groups comprises grouping body shapes into 45 styling entities. Although the number 45 is provided as a particular example corresponding to five horizontal body type characteristics, three vertical body type characteristics and three height characteristics, this number may vary according to changes styling anchors selected and associated attributes.

Reference is now made to FIG. 4C, there is provided a flowchart representing selected actions illustrating a possible classification method, which is generally indicated at 400C, for classifying garments into a finite number of garment molds as presented in FIG. 4A, step 404.

The method 400C may include the following steps:

In step 420—the system defines a set of garment types representing such as skirts, dresses, pants, jackets, tops and the like;

In step 422—the system defines a set of garment major classes, for each garment type corresponding to the garment molds; and

Optionally, in step 424—the system defines a set of garment sub-classes corresponding to garment parts associated with the garment types.

It is noted that garment parts refer to the components of the garment such as sleeve, waistline, neckline, length and the like.

Reference is now made to FIG. 4D, there is provided a flowchart representing selected actions illustrating a possible assignment method, which is generally indicated at 400D, for assigning one body anchor value of each of the body anchors to each body group.

The assignment method 400D is operable to assign each body shape one of N_st styling entities, where each styling entity comprising a unique combination of the body (styling) anchors. The number N_st represents the total number of styling entities and is equal to the number of combinations of vertical body type values, horizontal body type values and height values.

The method 400D may include the following steps:

In step 426—the system assigns the body group one value selected from the total number (N_horiz) of horizontal body type values;

In step 428—the system assigns the body group one value selected from the total number (N_vert) of vertical body type values; and

In step 430—the system assigns the body group one value selected from the total number (N_height) of height values.

Reference is now made to FIG. 5, there is provided a flowchart representing selected actions illustrating a possible logic of the garment-based styling recommendation function, which is generally indicated at 500, to the received request parameter.

The method 500 may include the following steps:

In step 512—the system obtains a first styling-score pertaining to a particular garment major class for the particular body group;

In step 514—the system obtains a second styling-score pertaining to a particular garment sub-class for the particular body group; and

In step 516—the system merges the first styling-score and the second styling-score according to styling rules for the particular body group to obtain a first-level combined styling-score.

The step of applying the styling recommendation function further may include the step of 518, as follows:

In step 518A—the system may obtain a third styling-score pertaining to garment length for the particular garment major class, and for the particular body group; and

In step 518B—the system may merge the third styling-score and the first-level combined styling-score according to styling rules for the particular body group to obtain a second-level combined styling-score.

It is noted that in general styling-scores may be provided pertaining to any number of sub-classes. Accordingly, in general, applying the styling recommendation function may further include any number of iterations of the step 520, as follows:

In step 520A—the system obtains a further styling-score pertaining to other garment-parts; and

In step 520B—the system merges the further styling-score and a previous-level combined styling-score according to styling rules for the particular body group to obtain a next-level combined styling-score.

It should be appreciated that the merging of styling-scores is actually iterative, so an nth-level combined styling score may be obtained by combining any (n+1) styling scores.

Furthermore, in practice, when moving on to the fourth styling level and also maybe adding more anchors to the body group as well as adding lifestyle-dependent styling parameters such as body weight, the algorithm may use machine learning engine in order to generate styling rules for multiple parameters.

### Outfit-Based Styling Application Flow:

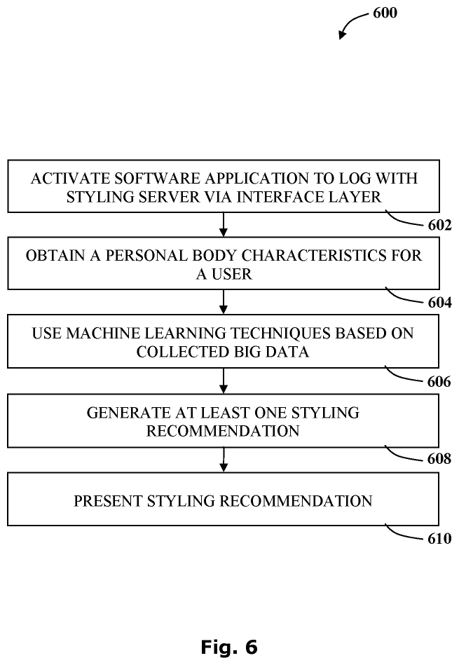

Reference is now made to FIG. 6, there is provided a flowchart representing selected actions illustrating a possible logic flow of an outfit-base styling recommendation software application, which is generally indicated at 600, using machine learning and big data techniques with or without the body group recommendation matrix.

The method 600 may include the following steps:

In step 602—activating the software application, executed on a user's remote communication device, to log onto a remote styling server via a styling application layer;

In step 604—the system obtains personal body characteristics for a user via the interface layer of the software application;

In step 606—the system uses machine learning technologies based on collected Big Data and associated techniques;

In step 608—the system generates at least one outfit styling recommendation;

In step 610—the system is presenting the styling recommendation. Optionally, the presentation may use the display module (FIG. 2, item 216) to provide the system visualization for the styling recommendations.

### Multi-Dimension Recommendation Matrix:

As described hereinabove, it is noted that the “Body Groups” and “Garment Classification” mechanisms together, may enable the overcoming of the ‘Fuzzy logic’ that features the Styling arena, by creating coherent and crucial Styling Rules that may be reflected in a multi-dimension recommendation matrix.

As illustrated in FIG. 7, there is provided an example of a styling matrix illustrating possible system logic, which is generally indicated at 700, of the styling recommendation system.

The styling matrix 700 is a multi-dimension recommendation matrix and may be constructed within the step of generating a styling recommendation function (as described, for example in FIG. 4A). The multi-dimension recommendation matrix, as presented, may include an array of cells, each of the cells corresponding to a particular body group, a particular garment major class and some garment-parts. Each of the cells may be assigned a styling score that may serve as a tool for determining the styling level, according to styling rules. Variously, the styling score may be selected from a group consisting of very good, good, ok and avoid, for example.

The system applies styling rules to aggregates the different styling scores extracted from the cells into a final styling score

It is noted that other types of styling scores or a different styling score may use a Boolean value, a numerical value, a unit interval, a value within a range, a percentage value, a decimal value, a numerical ratio value, a key word, a descriptive text, a tagged label and combinations thereof.

ASRS Use Cases implementations:

Various embodiments of the ASRS may be implemented, providing different aspects of the system. In order to clarify the principles of the ASRS, a particular embodiment is described hereinafter for illustrative purposes only.

The example outlines an “Automatic Styler” software application (App) including an “Outfit Calendar” sub system.

The Automatic Styler App may be used in a number of situations, by way of example three use cases are presented.

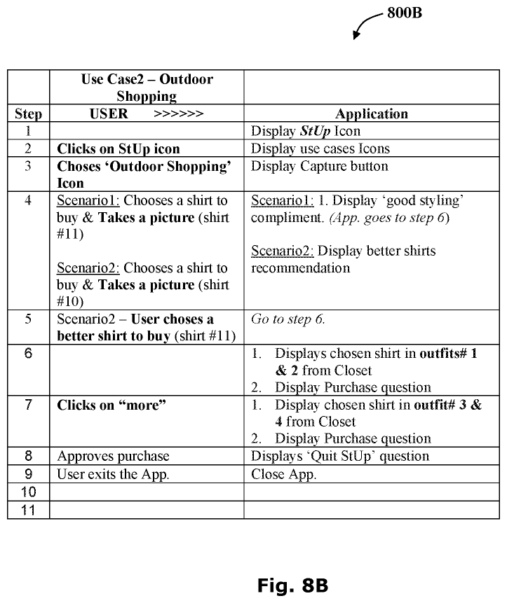

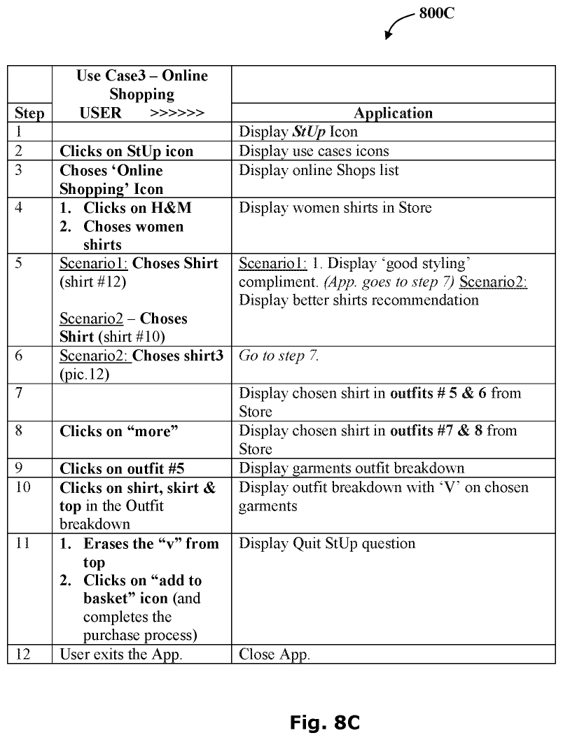

As illustrated in FIG. 8A, there is provided a first use case, which is generally indicated at 800A, for a user that may be going out to work and has no preconceived notion as to what to wear. The first use case 800A represents a possible process description of an Automatic Styling Application in a first use case example where the user is selecting an outfit to wear for going out or for travelling.

Accordingly, the user enters the application and chooses a “Going Out” option, for example. The user may be prompted to provide data pertaining to what the major event is that he/she will be attending, and/or to the user's current state of mind. It is noted that the state of mind may indicate the user's mood and what the user wishes to convey by the way he/she is dressed.

Upon receiving the user input data, the application may recommend at least one or even several outfits using garments from within the user's personal closet that suit the user's personal and physical characteristics and the event and state of mind the user has selected. These suggestions may be organized, for example, in a descending order, based on the outfits' grade or scoring value. Such a grade/score may be generated using the number of approvals or ‘likes’ the outfit generates in social networks and other machine-learning techniques.

As well as the recommended outfits, the application may indicate when the outfit was last worn ((n) days/weeks/months ago) and the number of times it was worn in the past weeks.

When the user clicks on the number of times an outfit was worn, the user may be routed to the Outfit Calendar sub system where the user can see all the events in which the user dressed in the same outfit and what other activities were scheduled for the user during those days.

Accordingly, where appropriate, the user may select one of the recommended outfits to wear. After choosing the outfit, the app may display a ‘board’ showing the pieces from which the outfit is created (for the user to identify easily what to take from his/her closet.)

As illustrated in FIG. 8B, there is provided a second use case, which is generally indicated at 800B, for a user that may be in a fashion department store and chooses an item (for example: a shirt) to buy.

The user may have no idea if the shirt suits him/her and with what clothes in his/her closet it goes well together. Accordingly, the user enters the automatic styling application and chooses the “Outdoor shopping” option, for example. The user may be prompted to enter data pertaining to the selected garment, for example by taking a picture of the shirt via a camera button icon, scanning a barcode on the garment label, entering a garment name or code or the like. The App may determine whether the garment suits the user or not and act accordingly:

Scenario1: When the item suits the user's physical characteristics well—the application may “flatter” the user for his/her good choice and presents the shirt in outfits from the user's closet with which it goes well together.

Scenario2: Alternatively, when the item suits the user's physical characteristics less well, such as when the shirt's shape does not suit his/her Body Group, the application may recommend other shirts from the same store, that may suit the user better.

After the user selects a shirt out of the options presented (the user's own choice or from the app's own recommendations), the application may present the selected shirt in outfits from the user's closet or from the store's collection, with which it goes well.

Before leaving the application, the user may be asked if he/she had bought the shirt.

As illustrated in FIG. 8C, there is provided a third use case, which is generally indicated at 800C, for a user that may be shopping online and chooses an item (for example: a shirt) to buy. The user may have no idea whether the shirt suits her and with what clothes in her closet it goes well together. Accordingly, the user enters the automatic styling application and chooses the “Online shopping” option.

The automatic styling application may then present a list of online stores with which the application is connected. The user may select the online store of choice from the list and picks a shirt to buy.

Scenario1: When the item suits the user's physical characteristics well—the application “flatters” the user for his/her good choice and present the shirt in outfits from the store's collection and from other online stores' collections, with which it goes well together.

Scenario2: When the item suits the user's physical characteristics less (such as where the shirt's color does not suit his/her skin complexion for example)—the application recommends other shirts from the store, that suit the user better.

In either case—the user may choose the shirt he/she wishes to buy, whether it is the one the user picked first or one of those recommended by the application. Accordingly, the application presents the shirt in outfits from the store's collection and from other online stores' collections, with which the shirt goes well together.

Where appropriate, the user may (but is not obligated to) ask to see with what outfits from his/her closet the shirt goes well. (Like in use-case2).

The user may then put the selected item in the virtual shopping cart along with any other item selected from among the recommended outfits from the stores' collection.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1-32. (canceled)

33. In a system comprising at least one server in communication with a communication network, said communication network being connected to at least one data repository, a method of operating the server to generate automatic styling recommendations in an improved manner, the method comprising:
categorizing the human body into a finite number of body groups by:
defining a set of body anchors each said body anchor representing a lifestyle-independent body characteristic; and
assigning each body group a value for each body anchor;
classifying garments into a finite number of fundamental garment molds;
generating a recommendation function using the body-groups and garment-molds, to create a multi-dimension styling-matrix operable to receive at least one request parameter and to return at least one garment recommendation according to styling rules;
receiving a recommendation request for a particular body group, said recommendation request characterized by at least one request parameter;
applying the recommendation function to the received request parameters; and
reporting a styling recommendation based upon the at least one garment recommendation returned by the recommendation function;
wherein said set of body anchors comprises all of the following:
a horizontal body type anchor;
a vertical body type anchor; and
a height anchor;
and each said body group represents one styling entity comprising a unique combination of said body anchors, by:
assigning said body group one value selected from N_horiz horizontal body type values;
assigning said body group one value selected from N_vert vertical body type values; and
assigning said body group one value selected from N_height height values;
such that there are a total of N_st styling entities, where N_st is equal to the number of combinations of N_horiz, N_vert and N_height.

34. The method of claim 33, wherein each said body group is assigned:
a horizontal body type anchor value selected from: A(“Pear); X(“Cherry”); H(“Banana”); V(“Strawberry”); O(“apple”);
a vertical body type anchor value selected from: high waistline, low waistline and mid waistline; and
a height anchor value selected from: below average, average and above average.

35. The method of claim 33, wherein the step of classifying garments into a finite number of garment molds comprises:
selecting a set of garment types;
for each said garment type, defining a set of garment major classes corresponding to said garment types and characterized by contours of garment silhouettes used in pattern making; and
defining a set of garment sub-classes corresponding to garment parts associated with said garment types.

36. The method of claim 33, wherein the step of generating a recommendation function comprises constructing a multi-dimension styling-matrix.

37. The method of claim 36, wherein the multi-dimension styling-matrix comprises an array of cells each of said cells corresponding to a particular body group and a particular garment major class, wherein each of said cells is assigned a styling-score according to said styling rules.

38. The method of claim 36, wherein the multi-dimension styling-matrix comprises an array of cells each of said cells corresponding to a particular body group and a particular garment sub-class, wherein each said cell is assigned a styling-score according to said styling rules.

39. The method of claim 36, wherein the multi-dimension styling-matrix comprises an array of cells each of said cells corresponding to a particular body group and wherein each said cell is assigned a styling-score selected from a group consisting of very good, good, ok and avoid.

40. The method of claim 39, wherein the step of applying said recommendation function comprises:
obtaining a first styling-score pertaining to a particular garment major class for said particular body group;
obtaining a second styling-score pertaining to a particular garment sub-class for said particular body group; and
merging said first styling-score and said second styling-score according to styling rules for said particular body group to obtain a first-level combined styling-score;
obtaining a third styling-score pertaining to garment length for said particular garment major class, and for said particular body group; and
merging said third styling-score and said first-level combined styling-score according to styling rules for said particular body group to obtain a second-level combined styling-score.

41. The method of claim 40, wherein the step of applying said recommendation function further comprises generating at least one further level combined styling score by:
obtaining a further styling-score pertaining to other garment-features; and
merging said further styling-score and a previous-level combined styling-score according to styling rules for said particular body group to obtain a next-level combined styling-score.

42. The method of claim 33, wherein the step of generating a recommendation function comprises:
accessing a database populated with styling data harvested from a distributed computing network; and
applying machine learning algorithms to refine said styling rules in said multi dimension styling matrix for all body groups.

43. The method of claim 33, wherein the step of reporting a styling recommendation further comprises:
generating a set of outfit styling-rules; and
applying said outfit styling rules to produce at least one outfit based recommendation comprising a combination of compatible said garments recommendations.

44. The method of claim 43, wherein the step of generating said set of outfit styling-rules comprises:
accessing a database populated with styling data harvested from a distributed computing network; and
applying machine learning algorithms to generate outfit styling rules for all body groups.

45. In a system comprising at least one server in communication with a communication network, said communication network being connected to at least one data repository, a method of operating the server to generate automatic styling recommendations in an improved manner, the method comprising:
categorizing the human body into a finite number of body groups by:
defining a set of body anchors each said body anchor representing a lifestyle-independent body characteristic; and
assigning each body group a value for each body anchor;
classifying garments into a finite number of fundamental garment molds;
generating a recommendation function using the body-groups and garment-molds, to create a multi dimension styling-matrix operable to receive at least one request parameter and to return at least one garment recommendation according to styling rules;
receiving a recommendation request for a particular body group, said recommendation request characterized by at least one request parameter;
applying the recommendation function to the received request parameters; and
reporting a styling recommendation based upon the at least one garment recommendation returned by the recommendation function;
wherein the step of classifying garments into a finite number of garment molds comprises:
selecting a set of garment types;
for each said garment type, defining a set of garment major classes corresponding to said garment types and characterized by contours of garment silhouettes used in pattern making; and
defining a set of garment sub-classes corresponding to garment parts associated with said garment types; and
wherein the step of generating a recommendation function comprises:
constructing a multi-dimension styling-matrix comprising an array of cells, each of said cells corresponding to a particular body group, a particular garment major class, and a particular garment sub-class, and
assigning each said cell a styling-score according to said styling rules; and
further wherein the step of applying said recommendation function comprises:
obtaining a first styling-score pertaining to a particular garment major class for said particular body group;
obtaining a second styling-score pertaining to a particular garment sub-class for said particular body group; and
merging said first styling-score and said second styling-score according to styling rules for said particular body group to obtain a first-level combined styling-score;
obtaining a third styling-score pertaining to garment length for said particular garment major class, and for said particular body group; and
merging said third styling-score and said first-level combined styling-score according to styling rules for said particular body group to obtain a second-level combined styling-score.

46. The method of claim 45, wherein the step of applying said recommendation function further comprises generating at least one further level combined styling score by:
obtaining a further styling-score pertaining to other garment-features; and
merging said further styling-score and a previous-level combined styling-score according to styling rules for said particular body group to obtain a next-level combined styling-score.

47. The method of claim 45, wherein the step of generating a recommendation function comprises:
accessing a database populated with styling data harvested from a distributed computing network; and
applying machine learning algorithms to refine said styling rules in said styling matrix for all body groups.

48. The method of claim 45, wherein the step of reporting a styling recommendation further comprises:
generating a set of outfit styling-rules; and
applying said outfit styling rules to produce at least one outfit based recommendation comprising a combination of compatible said garments recommendations.

49. The method of claim 48, wherein the step of generating said set of outfit styling-rules comprises:
accessing a database populated with styling data harvested from a distributed computing network; and
applying machine learning algorithms to generate outfit styling rules for all body groups.

50. The method of claim 45, wherein said set of garment types are selected from skirts, dresses, pants, jackets and tops, and wherein:
said selected garment parts associated with tops are selected from garment length, sleeves, and neckline shapes; said selected garment parts associated with skirts are selected from garment length and garment waistline position;
said selected garment parts associated with pants are selected from garment length and garment waistline position; said selected garment parts associated with dresses are selected from garment length, sleeves, neckline shapes and waistline position; and said selected garment parts associated with jackets are selected from garment length, sleeves, and neckline shapes.

51. An automatic styling recommendation system operable to provide personal styling recommendations, said styling recommendation system comprising:
a processing unit operable to manage and control algorithmic styling analysis;
a garment-based styling component operable to classify garments into a finite number of garment molds and to provide rule-based logic for said styling recommendation system;
a styling logic interface configured to provide a third party software module an interfacing layer with the styling logic component via the processing unit; and
a knowledge data repository unit operable to store said finite number of garment molds and a finite number of body groups categorized by a set of body anchors, each said body anchor representing a lifestyle-independent body characteristic;
wherein said styling recommendation system is operable to:
receive at least one request parameter;
produce at least one analysis result; and
report at least one outfit-based and or garment-based recommendation comprising said at least one analysis result, according to a set of styling rules based upon said finite number of garment molds and said finite number of body groups.

52. The automatic styling recommendation system of claim 51, further comprising a styling engine operable to update the knowledge data repository with data pertaining to said set of styling rules.
